(19) United States
(12) Patent Application Publication
(10) Pub. No.: US 2017/0313321 A1
(43) Pub. Date: Nov. 2, 2017

(54) VEHICLE CONTROL SYSTEM, VEHICLE CONTROL METHOD, AND VEHICLE CONTROL PROGRAM

(71) Applicant: HONDA MOTOR CO., LTD., Tokyo (JP)

(72) Inventor: Masahiko Asakura, Wako-shi (JP)

(73) Assignee: HONDA MOTOR CO., LTD., Tokyo (JP)

(21) Appl. No.: 15/494,938

(22) Filed: Apr. 24, 2017

(30) Foreign Application Priority Data
Apr. 28, 2016 (JP) 2016-092029

(51) Int. Cl. B60W 50/00; B60W 10/20; G01C 21/34; B60W 30/18; G05D 1/02; B60W 50/14; B60W 50/08

(52) U.S. Cl. CPC B60W 50/0097; B60W 30/18; B60W 10/20; G01C 21/3469; G05D 1/0217; B60W 2710/081; B60W 2710/0644; B60W 2550/402; B60W 2550/10; B60W 2540/18; B60W 2540/12; B60W 2540/10; B60W 2422/00; B60W 2420/52; B60W 2420/42; B60W 2050/146; B60W 50/14; B60W 50/082; B60W 2720/10; B60W 2720/24; B60W 2750/40; G05D 1/0276; G05D 1/024

(57) ABSTRACT

A vehicle control system includes: an automated driving controller executing automated driving that automatically performs at least one of speed control and steering control of a vehicle to allow the vehicle to travel to a set destination; a calculator which, referring to a plan of the automated driving, calculates an amount of energy expected to be consumed if the vehicle travels the guiding route from the current position of the vehicle to the destination by the automated driving; and a route changing section which changes the guiding route based on the amount of energy calculated by the calculator.

### CROSS REFERENCES TO RELATED APPLICATIONS

The present application claims priority under 35 U.S.C. §119 to Japanese Patent Application No. 2016-092029, filed Apr. 28, 2016, entitled “Vehicle Control System, Vehicle Control Method, and Vehicle Control Program.” The contents of this application are incorporated herein by reference in their entirety.

### BACKGROUND

### 1. Field

The disclosure relates to a vehicle control system, a vehicle control method, and a vehicle control program.

### 2. Description of the Related Art

A conventionally-known navigation system calculates the consumption of driving energy for traveling in a certain link included in map information, and calculates a recommended route based on the level of driving energy remaining in the vehicle and the consumption of driving energy, the recommended route being a route that minimizes the cost among routes through which the level of driving energy remaining in the vehicle will not fall below a predetermined threshold (see Japanese Unexamined Patent Application Publication No. 2011-075382, for example).

There is another vehicle navigation system including a guiding unit which guides the vehicle to an energy filling station by causing a display unit to display map information while superimposing the positions of retrieved reachable energy filling stations thereon. The vehicle navigation system further includes a criterion changing unit configured to change, in accordance with the travel conditions, the criterion based on which a determining unit is to determine whether or not the vehicle can travel to the destination (see Japanese Unexamined Patent Application Publication No. 2004-151053, for example).

In recent years, studies have been made on techniques to automatically control at least one of acceleration/deceleration and steering of a vehicle (hereinafter, automated driving). However, the conventional techniques do not manage the level of remaining energy by suitably using automated driving.

### SUMMARY

The present application was made in the light of the aforementioned circumstances and describes a vehicle control system, a vehicle control method, and a vehicle control program which are capable of suitably managing the remaining energy level using automated driving.

A first aspect of the disclosure is a vehicle control system including: an automated driving controller which executes automated driving that automatically performs at least one of speed control and steering control of a vehicle to allow the vehicle to travel to a set destination; a calculator which, referring to a plan of the automated driving, calculates an amount of energy expected to be consumed if the vehicle travels the guiding route from the current position of the vehicle to the destination by the automated driving; and a route changing section (a route changer) which changes the guiding route based on the amount of energy calculated by the calculator. The word “section” used in this application may mean a physical part or component of computer hardware or any device including a controller, a processor, a memory, etc., which is particularly configured to perform functions and steps disclosed in the application.

A second aspect of the disclosure is a vehicle control system according to the first aspect further including a first determination section which determines based on the amount of energy calculated by the calculator, whether the vehicle needs to be filled with energy before arriving at the destination; and a second determination section which, when the first determination section determines that the vehicle needs to be filled with the energy, determines whether there is a filling station for the energy around the guiding route, in which the route changing section changes the guiding route when the second determination section determines that there is no filling station for the energy around the guiding route.

A third aspect of the disclosure is the vehicle control system according to the second aspect, in which the route changing section changes the guiding route to a route on which there is a filling station for the energy and which leads to the destination when the second determination section determines that there is no filling station for the energy around the guiding route.

A fourth aspect of the disclosure is the vehicle control system according to the third aspect further including a storage which stores map information, in which the route changing section extracts filling stations for the energy on a map represented by the map information with reference to the map information stored in the storage, selects from the extracted filling stations a filling station first reachable by the vehicle from the current position of the vehicle, and changes the guiding route to a route on which the selected filling station is located.

A fifth aspect of the disclosure is the vehicle control system according to the second aspect according to the second aspect further including a guiding route calculator which calculates, as the guiding route, a route satisfying a predetermined condition among a plurality of routes from the current position of the vehicle or a set position to a set destination, in which the second determination section determines whether there is a filling station for the energy around a guiding route candidate determined as not satisfying the predetermined condition by the guiding route calculator in the calculating of the guiding route, and when the second determination section determines that there is a filling station for the energy around the guiding route candidate, the route changing section changes the guiding route to the guiding route candidate.

A sixth aspect of the disclosure is a vehicle control method to be executed by an in-vehicle computer, the method including: executing automated driving that automatically performs at least one of speed control and steering control of a vehicle to allow the vehicle to travel to a set destination; with reference to a plan of the automated driving, calculating an amount of energy expected to be consumed if the vehicle travels the guiding route from the current position of the vehicle to the destination by the automated driving; and changing the guiding route based on the amount of energy thus calculated.

A seventh aspect of the disclosure is a vehicle control program causing an in-vehicle computer to: execute automated driving that automatically performs at least one of speed control and steering control of a vehicle to allow the vehicle to travel to a set destination; with reference to a plan of the automated driving, calculate an amount of energy expected to be consumed if the vehicle travels the guiding route from the current position of the vehicle to the destination by the automated driving; and change the guiding route based on the amount of energy thus calculated. It is understood and well known in the art that such program may be provided in a form of a computer program product having instructions stored in a computer readable media and readable and executable by a computer such as a vehicle control device to execute the instructions.

According to the above-described aspects, the level of energy is managed by suitably using automated driving.

### BRIEF DESCRIPTION OF THE DRAWINGS

FIG. 1 is a view illustrating constituent components of a control system-mounted vehicle.

FIG. 2 is a functional block diagram of the vehicle control system and devices therearound.

FIG. 3 is a block diagram of an HMI.

FIG. 4 is a view illustrating the way the relative position of the control system-mounted vehicle to a travel lane is recognized by a system-mounted vehicle position recognizing section.

FIG. 5 is a view illustrating an example of an action plan generated for a certain zone.

FIG. 6 is a diagram illustrating an example of the configuration of a trajectory generating section of a first embodiment.

FIG. 7 is a view illustrating an example of trajectory candidates generated by a trajectory candidate generating section.

FIG. 8 is a view illustrating trajectory candidates generated by the trajectory candidate generating section with trajectory points K.

FIG. 9 is a view illustrating a lane change target position.

FIG. 10 is a diagram illustrating a speed generation model on the assumption that that three surrounding vehicles are moving at constant speed.

FIG. 11 is a diagram illustrating an example of the configuration of the HMI controller.

FIG. 12 is a diagram illustrating an example of mode-based restriction information.

FIG. 13 is a diagram illustrating an example of the configuration of an energy monitoring section.

FIG. 14 is a view illustrating an example of screen displayed when energy filling is necessary.

FIG. 15 is a diagram illustrating an example of the situation where the guiding route is changed to a fueling route.

FIG. 16 is a diagram illustrating another example of the situation where the guiding route is changed to a fueling route.

FIG. 17 is a flowchart illustrating an example of the flow of the process performed by the vehicle control system of the first embodiment.

FIG. 18 is a diagram illustrating an example of the situation where the guiding route is changed to a route candidate.

FIG. 19 is a diagram illustrating another example of the situation where the guiding route is changed to a route candidate.

### DESCRIPTION OF THE PREFERRED EMBODIMENTS

Hereinafter, a description is given of embodiments of a vehicle control system, a vehicle control method, and a vehicle control program of the disclosure with reference to the drawings.

### <Common Configuration>

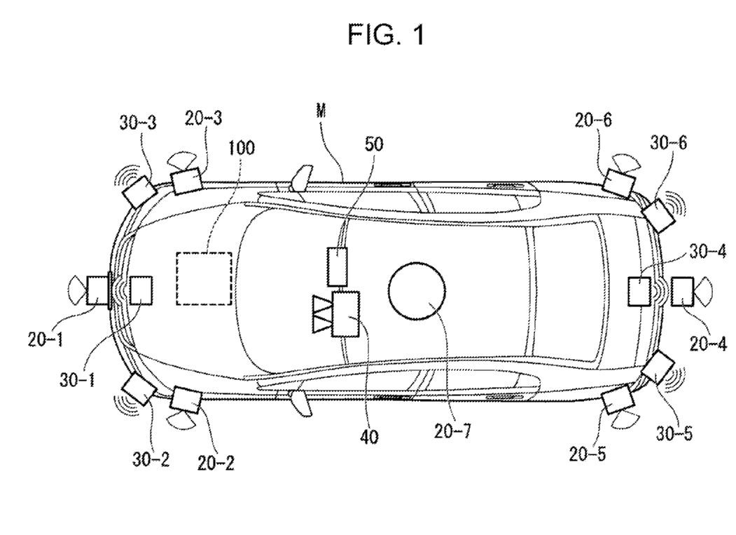

FIG. 1 is a view illustrating constituent components of a vehicle on which a vehicle control system 100 of each embodiment is mounted (hereinafter, referred to as a vehicle M). Examples of the vehicle on which the vehicle control system 100 is mounted are two-wheel, three-wheel, and four wheel automobiles, including automobiles powered by an internal combustion engine, such as a diesel or gasoline engine, electric vehicles powered by an electric motor, and hybrid vehicles including both an internal combustion engine and an electric motor. Electric vehicles are driven using electric power discharged from batteries such as secondary batteries, hydrogen fuel cells, metal fuel cells, and alcohol fuel cells, for example.

As illustrated in FIG. 1, the vehicle M is provided with sensors, including finders 20-1 to 20-7, radars 30-1 to 30-6, and a camera 40, a navigation device 50, and the vehicle control system 100.

The finders 20-1 to 20-7 are LIDARs (light detection and ranging or laser imaging detection and ranging) which measure the distance to an object by measuring scattering light for projected light, for example. For example, the finder 20-1 is attached to the front grill or the like, and the finders 20-2 and 20-3 are attached to side surfaces of the vehicle body, to door mirrors, within headlights, near side marker lamps, or the like. The finder 20-4 is attached to a trunk lid or the like, and the finders 20-5 and 20-6 are attached to lateral sides of the vehicle body, inside the tail lamp, or the like. Each of the aforementioned finders 20-1 to 20-6 has a detection range of about 150 degrees in the horizontal direction, for example. The finder 20-7 is attached to a roof or the like. The detection range of the finder 20-7 is 360 degrees in the horizontal direction, for example.

The radars 30-1 and 30-4 are long-distance millimeter-wave radars having a wider detection range in depth than the other radars, for example. The radars 30-2, 30-3, 30-5, and 30-6 are middle distance millimeter-wave radars having a narrower detection range in depth than the radars 30-1 and 30-4.

The finders 20-1 to 20-7 are referred to just as finders 20 below if not distinguished in particular, and the radars 30-1 to 30-6 are referred to just as radars 30 if not distinguished in particular. The radars 30 detect an object using a frequency modulated continuous wave (FM-CW) method, for example.

The camera 40 is a digital camera including a solid state image sensor such as a charge coupled device (CCD) or a complementary metal oxide semiconductor (CMOS), for example. The camera 40 is attached to upper part of the front windshield 90a provided in front of the vehicle, the back of the rear-view mirror, or the like. The camera 40 is configured to repeatedly capture an image of the front view from the vehicle M periodically. The camera 40 may be a stereo camera including plural cameras.

The configuration illustrated in FIG. 1 is just an example and may be partially omitted. The configuration of the vehicle M may additionally include another configuration.

### First Embodiment

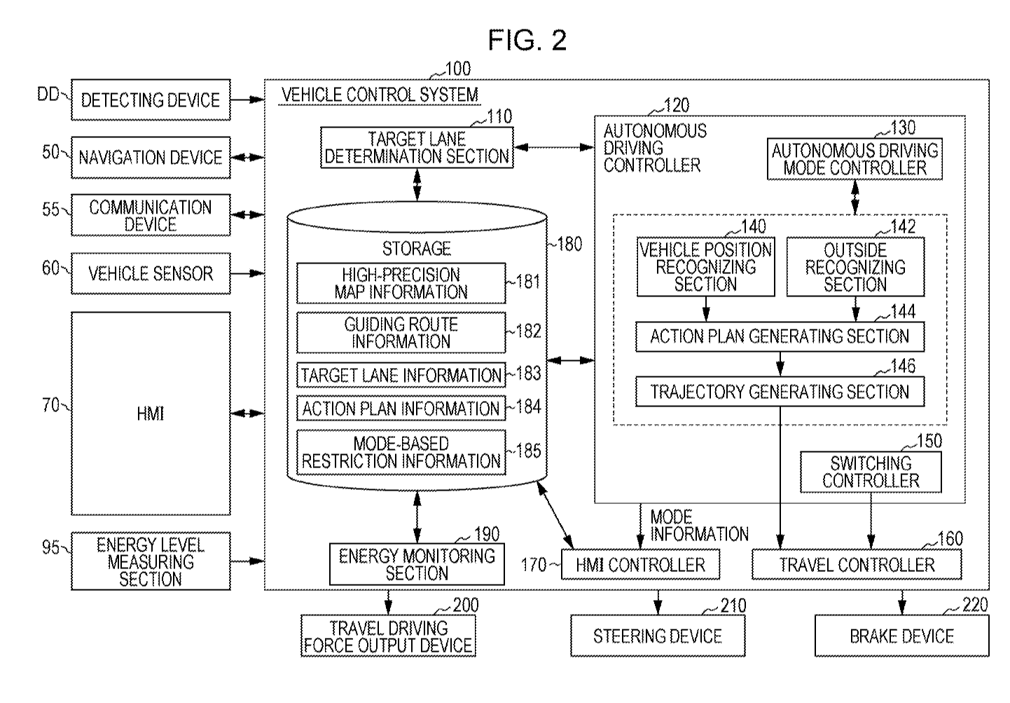

FIG. 2 is a functional block diagram of a vehicle control system 100 according to a first embodiment and other configurations therearound. The vehicle M is equipped with a detection device DD including the finders 20, radars 30, and camera 40, a navigation device 50, a communication device 55, a vehicle sensor 60, a human machine interface (HMI) 70, an energy level measuring section 95, the vehicle control system 100, a travel driving force output device 200, a steering device 210, and a brake device 220. These devices and equipment are connected to each other via a multiple communication line such as a controller area network (CAN), a serial communication line, a wireless communication network, or the like. The vehicle control system of the disclosure does not indicate only the vehicle control system 100 and may include the configurations (the detection device DD, HMI 70, or the like) other than the vehicle control system 100.

The navigation device 50 includes a global navigation satellite system (GNSS) receiver, map information (a navigation map), a touch panel display device functioning as a user interface, a speaker, a microphone, and the like. The navigation device 50 specifies the position of the vehicle M through the GNSS receiver and calculates a route (hereinafter, referred to as a guiding route) to guide the vehicle M from the specified position to the destination specified by the vehicle occupant. The navigation device 50 may calculate a route from the position (the nearest station, for example) specified by the vehicle occupant, instead of the position of the vehicle M, to the destination as the guiding route. The navigation device 50 is an example of a guiding route calculating section.

For example, the navigation device 50 evaluates each of plural route candidates from the guide starting point to the destination as the guide ending point in accordance with predetermined evaluation conditions. Herein, the guide starting point is set to the position specified by the occupant. The predetermined evaluation conditions include requirements such as those that the route minimizes travel time and distance, the route minimizes the expense for toll road and the like, and the route includes freeway. The predetermined evaluation conditions may be changed as needed by the occupant's operation. In the process of determining matching with the predetermined evaluation conditions, the navigation device 50 evaluates each of the route candidates using evaluation items including the number of energy filling stations, travel time, travel distance, whether the route includes toll road, and toll road fee, for example. The energy filling stations are facilities where the vehicle M can be filled with energy for driving the power source of the vehicle M, such as a gas station or a charging station, for example. The energy filling stations located within a predetermined range from the route candidate which is being evaluated are counted as energy filling stations of the route candidate of interest, for example. The energy filling stations located within the predetermined range are energy filling stations located on the road included in the route candidate being evaluated, for example.

As the guiding route, the navigation device 50 selects from the route candidates that satisfy the predetermined evaluation conditions, a route candidate which is given the totally highest rating in consideration of all of the evaluation items or which is given the highest rating in terms of some of the evaluation items. The evaluation conditions may be weighted by an occupant's operation. For example, the evaluation conditions may be weighted so that the route candidates involving shorter travel time are more preferentially selected or the route candidates involving more energy filing stations are more preferentially selected.

The navigation device 50 outputs information representing the calculated guiding route to the vehicle control system 100. The information representing the guiding route may include information representing the route candidates which are given the second and third highest ratings and are not selected as the guiding route, for example. The information represented as the guiding route is stored in a later-described storage 180 of the vehicle control system 100 as the guiding route information 182.

The navigation device 50 may be configured to specify or complement the position of the vehicle M with an inertial navigation system (INS) using outputs from the vehicle sensor 60, for example. The navigation device 50 provides voice guidance or navigating display of the route to the destination while the vehicle control system 100 is executing a manual driving mode. The configuration to specify the position of the vehicle M or the configuration to evaluate the route candidates may be provided independently of the navigation device 50. The navigation device 50 may be implemented by a function of a user's terminal device such as a smartphone or a tablet terminal, for example. In this case, the terminal device and vehicle control system 100 exchange information through wireless or wired communication.

The communication device 55 performs wireless communication using a cellular network, a Wi-Fi network, Bluetooth (registered trademark), dedicated short range communication (DSRC), or the like, for example. For example, the communication device 55 performs wireless communication with an information providing server of a system monitoring road traffic conditions, such as a vehicle information and communication system (VICS, registered trademark) and acquires information representing traffic conditions of the road where the vehicle M is traveling or the road where the vehicle M is to travel (hereinafter, the information is referred to as traffic information). The traffic information includes information on a traffic jam ahead, time required to pass through the traffic jam, accident/broken-down vehicle/roadwork information, speed limit/lane closure information, locations of parking spaces, and vacancy information of parking spaces and rest and service areas. The communication device 55 may acquire the aforementioned traffic situation information by communicating with wireless beacons provided for road shoulders or the like or communicating with another vehicle traveling near the vehicle M. The communication device 55 may acquire information concerning energy prices by communicating with an information providing server which investigate the price of energy at each energy filling station and provides the acquired information.

The vehicle sensor 60 includes a vehicle speed sensor detecting vehicle speed, an acceleration sensor detecting acceleration, a yaw-rate sensor detecting angular speed around the vertical direction, a direction sensor detecting the orientation of the vehicle M, and the like.

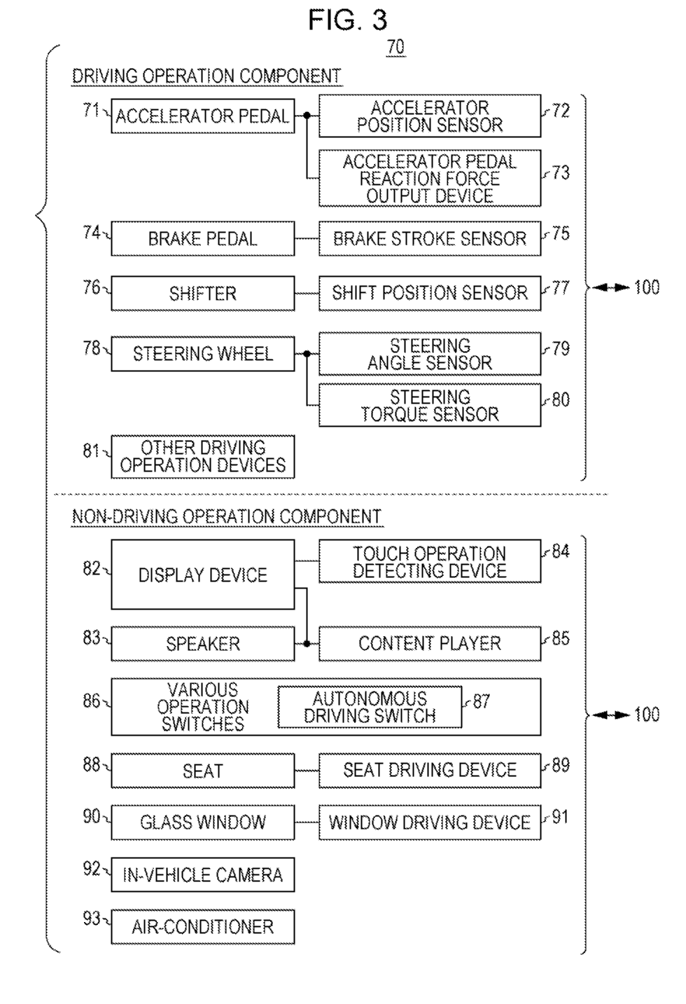

FIG. 3 is a block diagram of the HMI 70. The HMI 70 includes driving operation components and non-driving operation components. These are not clearly separated. The driving operation components may include a non-driving operation function (and vice versa).

The driving operation components of the HMI 70 include an accelerator pedal 71, an accelerator position sensor 72, an accelerator pedal reaction force output device 73, a brake pedal 74, a brake pedal stroke sensor (or a master pressure sensor) 75, a shifter 76, a shifter position sensor 77, a steering wheel 78, a steering angle sensor 79, a steering torque sensor 80, and another driving operation device 81.

The accelerator pedal 71 is an operator configured to accept an instruction from a vehicle occupant to accelerate the vehicle (or an instruction to decelerate the vehicle by a return operation). The accelerator position sensor 72 detects the amount of stroke of the accelerator pedal 71 and outputs an accelerator position signal representing the amount of stroke to the vehicle control system 100. The accelerator position sensor 72 may be configured to directly output the accelerator position signal to the travel driving force output device 200, steering device 210, or brake device 220 instead of the vehicle control system 100. The same goes for the other driving operation components described below. The accelerator pedal reaction force output device 73 outputs force to the accelerator pedal 71 in the opposite direction to the direction of operation in response to an instruction from the vehicle control system 100, for example.

The brake pedal 74 is an operator configured to accept an instruction from the vehicle occupant to decelerate the vehicle. The brake stroke sensor 75 detects the amount of stroke (or depression force) of the brake pedal 74 and outputs a brake signal representing the result of detection to the vehicle control system 100.

The shifter 76 is an operator configured to accept an instruction to change the shift position by the vehicle occupant. The shift position sensor 77 detects the shift position specified by the vehicle occupant and outputs a shift position signal representing the result of detection to the vehicle control system 100.

The steering wheel 78 is an operator configured to accept an instruction from the vehicle occupant to turn the vehicle M. The steering angle sensor 79 detects the operation angle of the steering wheel 78 and outputs a steering angle signal representing the result of detection to the vehicle control system 100. The steering torque sensor 80 detects torque applied to the steering wheel 78 and outputs a steering torque signal representing the result of detection to the vehicle control system 100.

The other driving operation devices 81 include a joy stick, a button, a dial switch, and a graphical user interface (GUI) switch, for example. The other driving operation devices 81 accept instructions to accelerate, decelerate, or turn the vehicle and output the same to the vehicle control system 100.

The non-driving operation components of the HMI 170 include a display device 82, a speaker 83, a touch operation detection device 84, a content player 85, various operation switches 86, a seat 88, a seat driving device 89, a glass window 90, a window driving device 91, an in-vehicle camera 92, a videoconferencing device 96, and an exterior display section 97.

The display device 82 is a liquid crystal display (LCD) or an organic electroluminescence (EL) display device and is attached to any section of the instrument panel or a proper place facing the front passenger's seat or a rear seat, for example. The display device 82 may be a head up display (HUD) projecting an image onto the front windshield or another window. The speaker 83 outputs audio. The touch operation detection device 84 detects the touch position in the display screen of the display device 82 and outputs the detected position to the vehicle control system 100 when the display device 82 is a touch panel. When the display device 82 is not a touch panel, the touch operation detection device 84 may be omitted.

The content player 85 includes a digital versatile disc (DVD) player, a compact disc (CD) player, a television receiver, or a device to generate various types of guidance images, for example. Each of the display device 82, speaker 83, touch operation detection device 84, and content player 85 may be partially or entirely shared with the navigation device 50.

The various operation switches 86 are provided at proper places in the compartment. The various operation switches 86 include an automated driving switch 87 which instructs to start (or to start in future) and stop automated driving. The automated driving switch 87 may be either a graphical user interface (GUI) switch or a mechanical switch. The various operation switches 86 may include switches to drive the seat driving device 89 and window driving device 91.

The seat 88 is a seat at which the vehicle occupant is seated. The seat driving device 89 freely drives the reclining angle, the position in the longitudinal direction, the yaw angle, and the like of the seat 88. The glass window 90 is provided for each door, for example. The window driving device 91 opens and closes the glass window 90.

The in-vehicle camera 92 is a digital camera using a solid-state imaging device such as a CCD or CMOS. The in-vehicle camera 92 is attached to such a position that the in-vehicle camera 92 can take an image of at least the head of the vehicle occupant performing driving operations, such as the rearview mirror, steering boss, or instrument panel. The camera 40 takes an image of the vehicle occupant periodically and repeatedly, for example. The air-conditioner 93 controls the temperature, humidity, and airflow within the compartment.

The energy level measuring section 95 measures the level of remaining energy to drive the power source of the vehicle M. When the vehicle M is an automobile powered by the internal combustion, for example, the energy level measuring section 95 measures the amount of remaining liquid fuel such as gasoline for combustion in the internal combustion engine. When the vehicle M is an automobile powered by an electric motor, for example, the energy level measuring section 95 measures the level of remaining battery that outputs electric power to drive the electric motor. When the vehicle M is a hybrid car including both an internal combustion engine and electric motor, for example, the energy level measuring section 95 may measure both the amount of remaining liquid fuel and the level of remaining battery. The energy level measuring section 95 outputs the information representing the measured remaining energy level to the vehicle control system 100.

Prior to the description of the vehicle control system 100, the travel driving force output device 200, steering device 210, and brake device 220 are described.

The travel driving force output device 200 outputs to driving wheels, travel driving force (torque) allowing the vehicle to travel. The travel driving force output device 200 includes an engine, a transmission, and an engine electronic control unit (ECU) controlling the engine when the vehicle M is an automobile powered by an internal combustion engine, for example. The travel driving force output device 200 includes a travel motor and a motor ECU controlling the travel motor when the vehicle M is an electric vehicle powered by an electric motor. The travel driving force output device 200 includes an engine, a transmission, an engine ECU, a travel motor, and a motor ECU when the vehicle M is a hybrid vehicle. When the travel driving force output device 200 includes only the engine, the engine ECU adjusts the throttle opening of the engine, the shift position, and the like in accordance with information inputted from a later-described travel controller 160. When the travel driving force output device 200 includes only the travel motor, the motor ECU adjusts the duty ratio of PWM signal given to the travel motor in accordance with the information inputted from the travel controller 160. When the travel driving force output device 200 includes both the engine and travel motor, the engine ECU and motor ECU control the travel driving force in cooperation in accordance with the information inputted from the travel controller 160.

The steering device 210 includes a steering ECU and an electric motor, for example. The electric motor applies force to a rack and pinion mechanism to change the direction of steered wheels, for example. The steering ECU drives the electric motor in accordance with information inputted from the vehicle control system 100 or information on the inputted steering angle and steering torque to change the direction of the steered wheels.

The brake device 220 is an electric servo-brake device including a brake caliper, a cylinder transmitting hydraulic pressure to the brake caliper, an electric motor generating hydraulic pressure in the cylinder, and a braking controller. The braking controller of the electric servo brake device controls the electric motor in accordance with information inputted from the travel controller 160 so that each wheel is supplied with brake torque in response to the braking operation. As a backup, the electric motor servo brake device may include a mechanism which transmits hydraulic pressure generated by operation of the brake pedal to the cylinder through a master cylinder. The brake device 220 is not limited to the above-described electric servo brake device and may be an electronically-controlled hydraulic brake device. The electronically-controlled hydraulic brake device controls an actuator in accordance with information inputted from the travel controller 160 to transmit the hydraulic pressure of the master cylinder to the cylinder. The brake device 220 may include a regenerative brake by the travel motor which can be included in the travel driving force output device 200.

### [Vehicle Control System]

The vehicle control system 100 is described below. The vehicle control system 100 is implemented by one or more processors or hardware having functions equivalent thereto, for example. The vehicle control system 100 may be a combination of electronic control units (ECUs) including a processor such as a central processing unit (CPU), a storage device, and a communication interface connected through an internal bus, micro-processing units (MPUs), or the like.

Back to FIG. 2, the vehicle control system 100 includes the target lane determination section 110, automated driving controller 120, travel controller 160, HMI controller 170, storage 180, and energy monitoring section 190 for example. The automated driving controller 120 includes an automated driving mode controller 130, a vehicle position recognizing section 140, an outside recognizing section 142, an action plan generating section 144, a trajectory generating section 146, a switching controller 150, for example.

Some or all of the target lane determination section 110, each section of the automated driving controller 120, and travel controller 160 are implemented by a processor executing a program (software). Alternatively, some or all of the same may be implemented by hardware such as large scale integration (LSI) or application specific integrated circuit (ASIC) or may be implemented by a combination of software and hardware.

The storage 180 stores information including high-precision map information 181, guiding route information 182, target lane information 183, action plan information 184, and mode-based restriction information 185, for example. The storage 180 is implemented by a read only memory (ROM), a random access memory (RAM), a hard disk drive (HDD), a flash memory, and the like. The program executed by the processor may be stored in the storage 180 in advance or may be downloaded from an external device through in-vehicle Internet equipment or the like. The program may be installed in the storage 180 by inserting a portable storage medium storing the program into a drive device. The vehicle control system 100 may be distributed to plural computer devices.

The target lane determination section 110 is implemented by a MPU, for example. The target lane determination section 110 divides the guiding route into plural blocks with reference to the guiding route information 182 outputted from the navigation device 50. The target lane determination section 110 divides the guiding route every 100 m in the travel direction of the vehicle M, for example. The target lane determination section 110 determines the target lane in which the vehicle M is to travel, for each block of the guiding route with reference to the high-precision map information 181. The target lane determination section 110 determines that the vehicle is to travel in the “X-th” lane from the left, for example. When the guiding route includes a diverging point, a merging point, or the like, for example, the target lane determination section 110 determines the target lanes such that the vehicle M can travel in a reasonable route for safely passing the diverging point, the merging point, or the like toward the destination. The target lane determined by the target lane determination section 110 is stored in the storage 180 as the target lane information 183.

The target lane determination section 110 may determine the target lane for a route other than the guiding route with reference to the guiding route information 182. In this case, the target lane information 183 may include both the target lane determined for the guiding route and the target lane determined for a route other than the guiding route.

The high-precision map information 181 is map information more precise than the navigation map of the navigation device 50. The high-precision map information 181 includes information on the center of each lane or boundaries thereof, for example. The high-precision map information 181 may include road information, traffic control information, address information (addresses and zip codes), facility information, telephone number information, and the like. The road information may include information representing types of roads such as freeways, toll roads, national highways, and prefectural roads, the number of lanes of each road, the width of each lane, the road gradient, the position of each road (three-dimensional coordinates including the longitude, latitude, and altitude), the curvature of each curve, positions of merging and diverging points in each lane, and road signs. The traffic control information includes information on lanes blocked due to construction, traffic accidents, traffic jam, and the like. The facility information may include information representing whether each facility existing on the high-precision map falls into the aforementioned energy filling stations or information representing the type of energy that each energy filling station supplies, such as gasoline, electric energy, or hydrogen.

The automated driving mode controller 130 determines the mode of automated driving carried out by the automated driving controller 120. The mode of automated driving in the embodiment includes the following modes. The following modes are shown just by way of example, and the number of modes of automated driving may be determined properly.

### [Mode A]

Mode A is a mode in which the automated driving degree is the highest. When Mode A is in execution, every vehicle control, including complicated merge control, is automatically conducted, and it is unnecessary for the vehicle occupant to keep watch on the circumstance around the vehicle M and the state of the vehicle M.

### [Mode B]

Mode B is a mode in which the automated driving degree is the next highest to Mode A. When Mode B is in execution, every vehicle control is automatically conducted in principle, but the driving operation of the vehicle M is handed over to the vehicle occupant in some situations. It is therefore necessary for the vehicle occupant to keep watch on the circumstances around the vehicle M and the state of the vehicle M.

### [Mode C]

Mode C is a mode in which the automated driving degree is the next highest to Mode B. When Mode C is in execution, the vehicle occupant needs to perform confirmation operation for the HMI 70 in accordance with the situation. In Mode C, automatic lane change is conducted when the vehicle occupant is notified of the time to change lanes and performs operation to change lanes for the HMI 70, for example. It is therefore necessary for the vehicle occupant to keep watch on the circumstances around the vehicle M and the state of the vehicle M.

The automated driving mode controller 130 determines the mode of automated driving based on an operation by the vehicle occupant for the HMI 70, an event determined by the action plan generating section 144, the traveling style determined by the trajectory generating section 146, and the like. The mode of automated driving is provided to the HMI controller 170. There may be limitations set on the modes of automated driving depending on the capabilities of the detection device DD of the vehicle M or the like. When the detection device DD has low capabilities, Mode A is not executed, for example. Any mode of automated driving can be switched to a manual driving mode through an operation for a driving operation component in the HMI 70 (override).

The vehicle position recognizing section 140 of the automated driving controller 120 recognizes the lane where the vehicle M is traveling (traveling lane) and the relative position of the vehicle M to the travel lane based on the high-precision map information 181 stored in the storage 180 and information inputted from the finders 20, radars 30, camera 40, navigation device 50, or vehicle sensor 60.

The vehicle position recognizing section 140 recognizes the travel lane by comparing the pattern of road lines recognized from the high-precision map information 181 with the pattern of road lines around the vehicle M recognized from the image taken by the camera 40. The recognition may be performed considering the position of the vehicle M acquired from the navigation device 50 and the results of processing by INS.

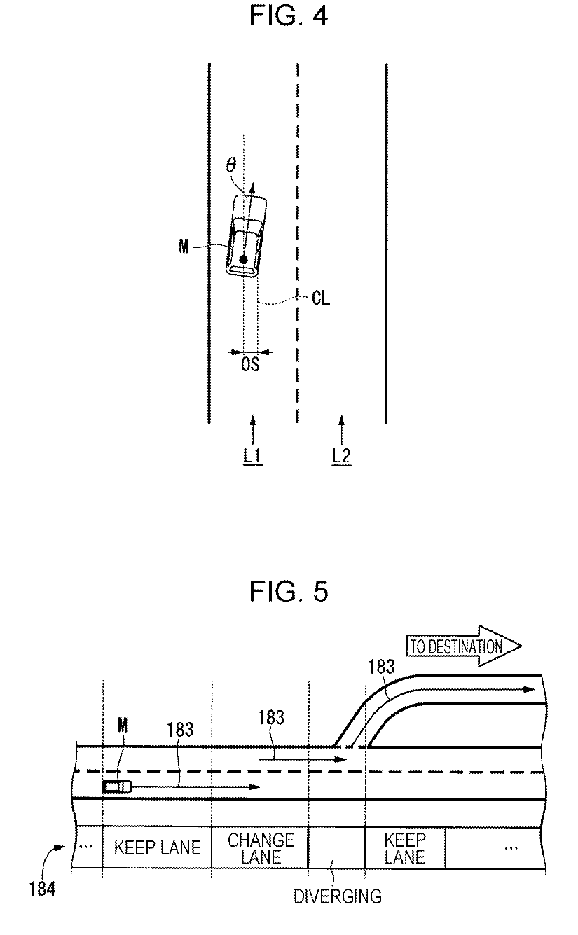

FIG. 4 is a diagram illustrating how the relative position of the vehicle M to a travel lane L1 is recognized by the vehicle position recognizing section 140. As the relative position of the vehicle M to the travel lane L1, the vehicle position recognizing section 140 recognizes a deviation OS of the reference point (the center of gravity, for example) of the vehicle from the center CL of the travel lane L1 and an angle θ between the direction of travel of the vehicle M and the center CL of the travel lane L1. Instead of the aforementioned recognition, the vehicle position recognizing section 140 may recognize the position of the reference point of the vehicle M relative to any side edge of the travel lane L1 as the relative position of the vehicle M to the travel lane L1. The relative position of the vehicle M recognized by the vehicle position recognizing section 140 is provided to the target lane determination section 110.

The outside recognizing section 142 recognizes the positions of surrounding vehicles and conditions of the surrounding vehicles such as speed and acceleration based on information inputted from the finders 20, radars 30, camera 40, and the like. The surrounding vehicles refer to vehicles which are traveling around the vehicle M in the same direction as the vehicle M, for example. The position of each surrounding vehicle is represented by a representative point thereof, such as the center of gravity or corners of the vehicle or may be represented by a region expressed in the vehicle's outline. The conditions of each surrounding vehicle may include information on the acceleration of the same and whether the vehicle of interest is changing lanes or is going to change lanes. Such information is known based on the information from the above described various devices. In addition to the surrounding vehicles, the outside recognizing section 142 may recognize the positions of guardrails, telephone poles, parked vehicles, pedestrians, and other objects.

The action plan generating section 144 set the starting point of automated driving and/or the destination of the same on the guiding route with reference to the guiding route information 182. The starting point of automated driving may be the current position of the vehicle M or the position where the operation to start automated driving is performed. The action plan generating section 144 generates an action plan for a zone between the starting point and destination of automated driving. Alternatively, the action plan generating section 144 may generate an action plan for an arbitrary section. For example, the action plan generating section 144 may generate an action plan by setting the starting point and/or destination of automated driving in a route other than the guiding route.

The action plan is composed of plural events which are executed sequentially, for example. The events include: a deceleration event that decelerates the vehicle M; an acceleration event that accelerates the vehicle M; a lane keeping event that causes the vehicle M to travel in the current travel lane; a lane changing event that causes the vehicle M to change lanes; an overtaking event that causes the vehicle M to overtake the vehicle traveling ahead; a diverging event that causes the vehicle M to move to a desired lane at a diverging point or keeps the vehicle M traveling in the current travel lane; a merging event that causes the vehicle M to accelerate or decelerate in a merging lane, which merges into a main lane, to move to the main lane; and a handover event that changes the driving mode from the manual driving mode to the automated driving mode at the starting point of automated driving and from the automated driving mode to the manual driving mode at the scheduled end point of automated driving. The action plan generating section 144 sets a lane changing event, a diverging event, or a merging event at a place where the target lane determined by the target lane determination section 110 is changed. The information indicating the action plan generated by the action plan generating section 144 is stored in the storage 180 as the action plan information 184.

FIG. 5 is a diagram illustrating an example of action plans generated for a certain section. As illustrated in FIG. 5, the action plan generating section 144 generates an action plan necessary for the vehicle M to travel through the target lane indicated by the target lane information 183. The action plan generating section 144 may dynamically change the action plan independently of the target lane information 183 as the situations of the vehicle M changes. For example, the action plan generating section 144 changes the event set for a block where the vehicle M is scheduled to travel when the speed of one of the surrounding vehicles recognized by the outside recognizing section 142 exceeds a threshold value while the vehicle M is traveling or when a surrounding vehicle traveling in the lane next to the travel lane of the vehicle M moves toward the travel lane of the vehicle M. In an action plan configured so that the lane changing event is executed after the lane keeping event, for example, when a vehicle is recognized travelling from behind at a speed higher than the threshold value in the lane to which the vehicle is scheduled to move, the action plan generating section 144 may change the event subsequent to the lane keeping event from the lane changing event to the deceleration event, lane keeping event, or the like. The vehicle control system 100 therefore allows the vehicle M to automatically travel safely even when the external situation has changed.

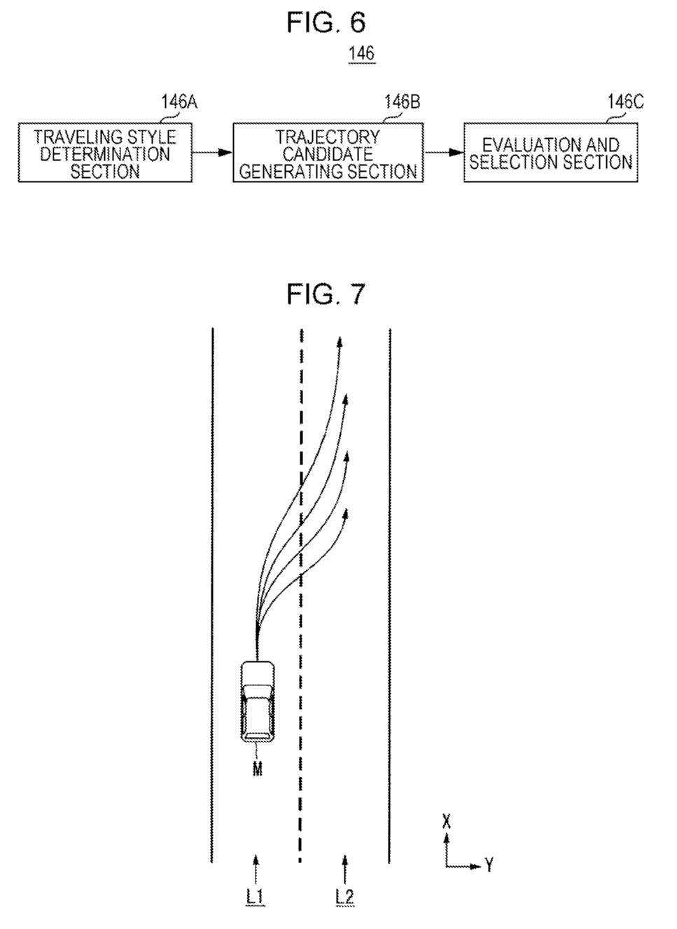

FIG. 6 is a diagram illustrating an example of the configuration of the trajectory generating section 146 of the first embodiment. The trajectory generating section 146 includes a travelling style determination section 146A, a trajectory candidate generating section 146B, and an evaluation and selection section 146C, for example.

The travelling style determination section 146A determines the travelling style to be any one of constant speed travel, following travel, slow following travel, deceleration travel, curve travel, obstacle avoiding travel and the like. When there are no other vehicles in front of the vehicle M, the travelling style determination section 146A sets the travelling style to the constant speed travel. To cause the vehicle M to travel following the vehicle ahead, the travelling style determination section 146A sets the travelling style to the following travel. In a traffic jam or the like, the travelling style determination section 146A sets the travelling style to the slow following vehicle. The travelling style determination section 146A sets the travelling style to the deceleration travel when the vehicle in front of the vehicle M is recognized decelerating by the outside recognizing section 142 or when an event that stops or parks the vehicle M is to be executed. When it is recognized by the outside recognizing section 142 that the vehicle M is entering a curve, the travelling style determination section 146A sets the travelling style to the curve travel. When an obstacle is recognized in front of the vehicle M by the outside recognizing section 142, the travelling style determination section 146A sets the travelling style to the obstacle avoiding travel. At the process of executing the lane changing event, overtaking event, diverging event, merging event, handover event, or the like, the travelling style determination section 146A determines the travelling style in accordance with the respective events.

The trajectory candidate generating section 146B generates a trajectory candidate based on the travelling style determined by the travelling style determination section 146A. FIG. 7 is a diagram illustrating examples of the trajectory candidate generated by the trajectory candidate generating section 146B. FIG. 7 illustrates trajectory candidates generated when the vehicle M is scheduled to move from a lane L1 to a lane L2.

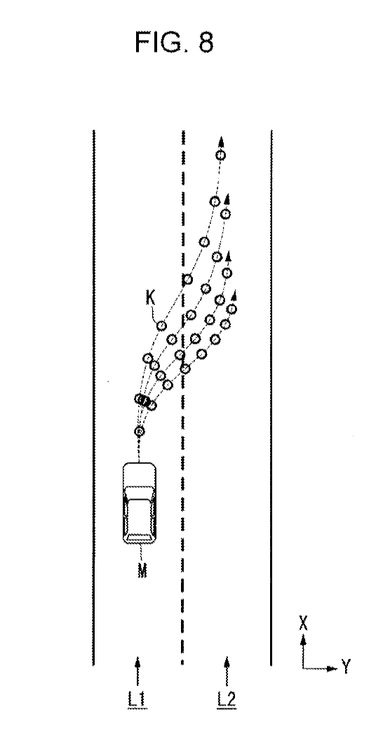

The trajectory candidate generating section 146B determines a trajectory (as illustrated in FIG. 7) as a group of target positions (trajectory points K) that the reference position (the center of gravity or the center of the rear wheel axis) of the vehicle M is to reach at predetermined intervals in future. FIG. 8 is a diagram illustrating trajectory candidates generated by the trajectory candidate generating section 146B with the trajectory points K. The wider the intervals of the trajectory points K, the higher the speed of the vehicle M. The narrower the intervals of the trajectory points K, the lower the speed of the vehicle M. The trajectory candidate generating section 146B therefore gradually increases the intervals of the trajectory points K in order to accelerate the vehicle M and gradually reduces the intervals of the trajectory points K in order to decelerate the vehicle M.

Since each trajectory point K includes a speed component as described above, the trajectory candidate generating section 146B needs to give target speed to each trajectory point K. The target speed is determined in accordance with the travelling style determined by the travelling style determination section 146A.

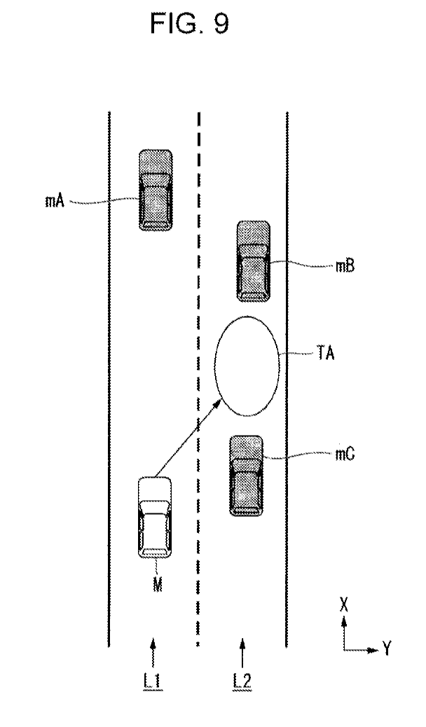

Herein, a description is given of a method of determining the target speed in the process of lane change (including diverging). The trajectory candidate generating section 146B first sets a lane change target position (or a merge target position). The lane change target position is set as a relative position to surrounding vehicles and determines which surrounding vehicles the vehicle M is to move between. The trajectory candidate generating section 146B determines the target speed at changing lanes based on the lane change target position in relation to three surrounding vehicles. FIG. 9 is a diagram illustrating the lane change target position TA. In FIG. 9, L1 indicates the lane where the vehicle M is traveling while L2 indicates the adjacent lane. The surrounding vehicle traveling just in front of the vehicle M is defined as a preceding vehicle mA. The surrounding vehicle traveling just in front of the lane change target position Ta is defined as a front reference vehicle mB. The surrounding vehicle traveling just behind the lane change target position Ta is defined as a rear reference vehicle mC. The vehicle M needs to accelerate or decelerate in order to move to the side of the lane change target position. In this process, it is necessary to prevent the vehicle M from reaching the preceding vehicle mA. The trajectory candidate generating section 146B therefore predicts the situation of the three surrounding vehicles in future and determines the target speed so that the vehicle M does not interfere with the surrounding vehicles.

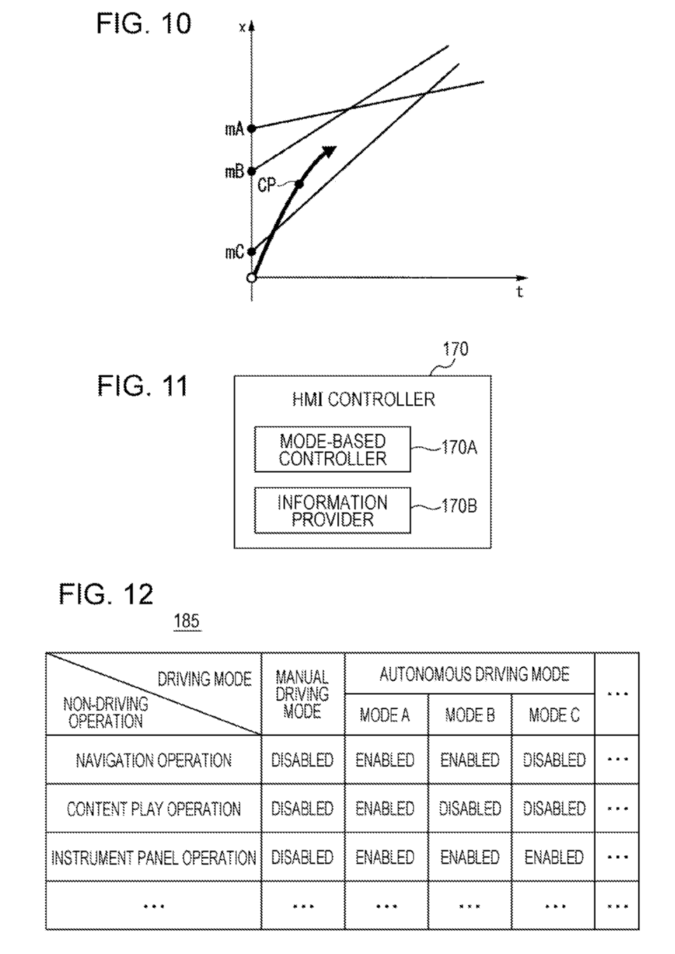

FIG. 10 is a diagram illustrating a speed generation model based on the assumption that the three surrounding vehicles travel at constant speeds. In FIG. 10, the straight lines extending from mA, mB, and mC represent displacement in the travel direction on the assumption that the three surrounding vehicles travel at constant speeds. The vehicle M must be located between the front and rear reference vehicles mB and mC at a point CP where the vehicle M completes the lane change and must be located behind the preceding vehicle mA before the point CP. Under such restrictions, the trajectory candidate generating section 146B develops plural time-series patterns of the target speed to the end of the lane change. The trajectory candidate generating section 146B develops plural trajectory candidates as illustrated in FIG. 8 by applying a model, such as a spline curve, to the time-series patterns of the target speed. The motion patterns of the three surrounding vehicles may be predicted on the assumption that the three surrounding vehicles travel at constant speed as illustrated in FIG. 10 but also on the assumption that the three surrounding vehicles travel at constant acceleration or constant jerk.

The evaluation and selection section 146C evaluates the trajectory candidates generated by the trajectory candidate generating section 146B from two viewpoints of planning and safety, for example, and selects a trajectory to be outputted to the travel controller 160. From the viewpoint of planning, the evaluation and selection section 146C gives a high rating to a trajectory which is compatible with a plan already generated (an action plan, for example) and has a short length. For example, to move to the right lane, the evaluation and selection section 146C does not give a lower rating to a trajectory of the vehicle M which involves moving to the left lane and then returning to the right lane. From the viewpoint of safety, the evaluation and selection section 146C gives a higher rating to such a trajectory that the vehicle is more distant from an object (the surrounding vehicles or the like) at each trajectory point with fewer changes in acceleration, deceleration, and steering angle.

The switch controller 150 mutually switches between the automated driving mode and manual driving mode based on a signal inputted from the automated driving switch 87. The switching controller 150 switches from the automated driving mode to the manual driving mode based on operations for the driving operation components of the HMI 70 to make an instruction to accelerate, decelerate, or steer the vehicle M. When the amount of operation indicated by a signal inputted from the driving operation components of the HMI 70 has continued to exceed the threshold value for a reference period of time or more, the switching controller 150 switches the driving mode from the automated driving mode to the manual driving mode (override). The switching controller 150 may restore the vehicle M to the automated driving mode when no operation for the driving operation components of the HMI 70 is detected for a predetermined period of time after switching to the manual driving mode for override.

The travel controller 160 controls the travel driving force output device 200, steering device 210, and brake device 220 so that the vehicle M passes along the trajectory generated by the trajectory generating section 146 as scheduled.

FIG. 11 is a diagram illustrating an example of the configuration of the HMI controller 170. The HMI controller 170 includes a mode-based controller 170A and information provider 170B, for example.

Upon being notified of information of the mode of automated driving from the automated driving controller 120, the mode-based controller 170A controls the HMI 70 in accordance with the type of the mode of automated driving with reference to the mode-based restriction information 185.

FIG. 12 is a diagram illustrating an example of the mode-based restriction information 185. The mode-based restriction information 185 illustrated in FIG. 12 includes manual driving mode and automated driving mode as items of the driving mode. The automated driving mode includes Mode A, Mode B, and Mode C as described above. As items of non-driving operation, the mode-based restriction information 185 includes navigation operation which is operation for the navigation device 50, content play operation which is operation for the content player 85, and instrument panel operation which is operation for the display device 82. In the example of the mode-based restriction information 185 illustrated in FIG. 12, whether the vehicle occupant is allowed to operate each non-driving operation component is set based on the driving mode described above. However, the target interface devices are not limited to the aforementioned non-driving operation components.

The mode-based controller 170A refers to the mode-based restriction information 185 based on the information on the mode acquired from the automated driving controller 120 and determines enabled devices (the navigation device 50 and part or all of the HMI 70) and disabled devices. Based on the determination result, the HMI controller 170 controls whether to accept the occupant's operation for the navigation device 50 or the non-driving operation components of the HMI 70.

When the driving mode executed by the vehicle control system 100 is the manual driving mode, for example, the vehicle occupant operates configuration of the driving operation components (the accelerator pedal 71, brake pedal 74, shifter 76, and steering wheel 78) of the HMI 70. When the driving mode executed by the vehicle control system 100 is Mode B or Mode C of the automated driving mode, for example, the vehicle occupant is required to observe the surroundings of the vehicle M. In such a case, to prevent the vehicle occupant from being distracted by an action (operation for the HMI 70, for example) other than driving, the mode-based controller 170A makes a control so that operations for some or all of the non-driving operation components of the HMI 70 are disabled. In this process, in order to cause the vehicle occupant to observe the surroundings of the vehicle M, the mode-based controller 170A may cause the display device 82 to display surrounding vehicles recognized around the vehicle M by the outside recognizing section 142 and the conditions of the surrounding vehicles in an image and allow the HMI 70 to accept a confirmation operation depending on the situation of the traveling vehicle M.

When the driving mode is Mode A of the automated driving mode, the mode-based controller 170A may make a control to relax the restrictions concerning the driver distraction and allow the non-driving operation components of the HMI 70, which are not allowed to be operated in the other modes, to accept occupant's operations. For example, the mode-based controller 170A causes the display device 82 to display video, causes the speaker 83 to output audio, and causes the content player 85 to play contents from a DVD or the like. The contents which are played by the content player 85 may include various types of contents concerning entertainment such as TV programs as well as contents stored in DVDs and the like. The “content play operation” illustrated in FIG. 11 may also include content operation concerning such entertainment.

The information provider 170B informs the vehicle occupant of various types of information using the display device 82, speaker 83, and the like of the HMI 70 based on the result of determination by a later-described energy monitoring section 190. The aforementioned information is described in detail later.

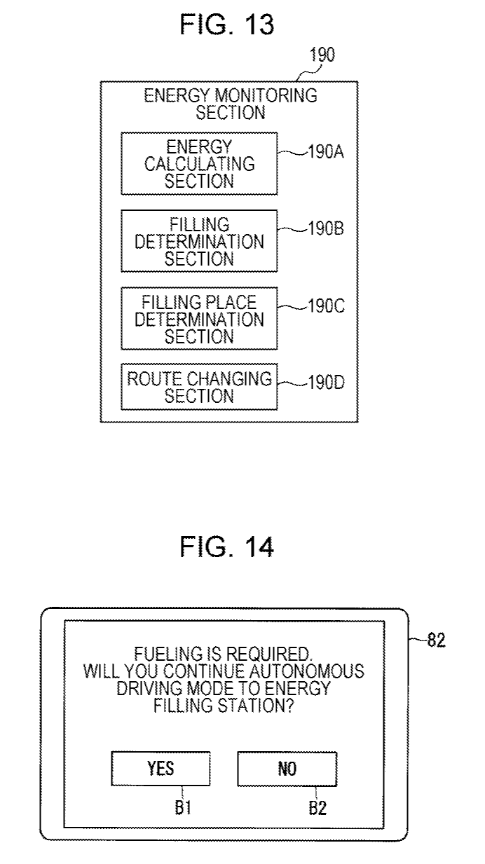

FIG. 13 is a diagram illustrating an example of the configuration of the energy monitoring section 190. The energy monitoring section 190 includes an energy calculating section 190A, a filling determination section 190B, a filling place determination section 190C, and a route changing section 180D. The filling determination section 190B is an example of a first determination section, and the filling place determination section 190C is an example of a second determination section.

The energy calculating section 190A calculates an amount of energy expected to be consumed in future (hereinafter, referred to as an expected energy consumption) in order for the vehicle M to arrive at the destination based on the guiding route information 182 outputted from the navigation device 50. For example, the energy calculating section 190A calculates an expected energy consumption for each driving block of the guiding route based on the type of the event of the driving block with reference to the action plan information 184. For example, in a driving block where a lane keeping event is planned, the expected energy consumption is more likely to be smaller than in driving blocks with the other events. This is because the lane keeping event does not involve acceleration/deceleration control or steering control at high frequency. In a driving block in which a lane changing or overtaking event is planned, it is necessary to change lanes in accordance with the speed of surrounding vehicles, and acceleration/deceleration control or steering control is performed more frequently. Accordingly, the expected energy consumption is likely to be larger in the driving block.

The energy calculating section 190A may calculate the expected energy consumption for each block of a route other than the guiding route based on the type of the event of the block of the other route.

The energy calculating section 190A may calculate as the expected energy consumption, the amount of energy consumed by the vehicle M by assuming that the vehicle M travels at the same speed as the referential speed of the road specified by the guiding route from the current position to the destination. The referential speed is the legal speed, average speed, or the like of the road. The energy calculating section 190A may calculate the expected energy consumption in future using an index obtained by dividing the past energy consumption by unit time, unit distance, or the like, for example. When it is found that there is a traffic jam, a traffic accident, or the like in the road specified by the guiding route with reference to traffic information obtained by the communication device 55, the energy calculating section 190A may calculate the expected energy consumption by considering the time taken to ease the traffic jam or to resolve the accident or the like.

The filling determination section 190B determines, based on the remaining energy level measured by the energy level measuring section 95 and the calculated expected energy consumption, whether the vehicle M needs to be filled with energy on the way to the destination. For example, the filling determination section 190B determines that the vehicle M needs to be filled with energy when the expected energy consumption is equal to or larger than the measured remaining energy level. In the following description, the point of time when the expected energy consumption becomes equal to or larger than the measured remaining energy level is referred to as a travel limit point P_{LIM}. When determining that the vehicle M needs to be filled with energy, the filling determination section 190B notifies the information provider 170B of the determination result. The information provider 170B then informs the vehicle occupant of predetermined information, using the display device 82 or speaker 83 of the HMI 70 or the like. The predetermined information is information letting the vehicle occupant know that the vehicle M needs to be filled with energy, for example.

FIG. 14 is a view illustrating an example of the screen displayed in the situation where the vehicle M needs to be filled with energy. As illustrated in FIG. 14, characters, images, and the like representing that the vehicle M needs to be filled with energy are displayed in the screen of the display device 82, for example. Moreover, the screen may include selection buttons used to select whether to continue the automated driving mode to the energy filling station. For example, when a button B1 to continue the automated driving mode is selected with a touch operation, the automated driving mode is allowed to continue. When a button B2 to stop the automated driving mode is selected with a touch operation, the automated driving mode is not allowed to continue. When the button B2 is selected, the aforementioned switching controller 150 switches the driving mode from the automated driving mode to the manual driving mode.

When the filling determination section 190B determines that the vehicle M needs to be filled with energy, the filling place determination section 190C determines whether there is an energy filling station around the guiding route to the travel limit point P_{LIM} with reference to the guiding route information 182. When there is an energy filling station around the guiding route, the filling place determination section 190C temporarily sets the destination (hereinafter, referred to as a provisional destination) to the energy filling station. The filling place determination section 190C notifies the action plan generating section 144 or trajectory generating section 146 of setting of the provisional destination. Upon being notified, the action plan generating section 144 changes the current event to a lane changing event, a merging event, or the like so that the vehicle M be pulled into the energy filling station set as the provisional destination from the guiding route. When the vehicle M arrives near the provisional destination, the trajectory generating section 146 generates a trajectory so that the vehicle M be steered from the current lane to the energy filling station as the provisional destination (the travel direction of the vehicle M be directed to the energy filling station).

When the filling place determination section 190C determines that there is no energy filling station around the guiding route, the route changing section 190D extracts positions of energy filling stations on a high-precision map with reference to the high-precision map information 181. Among the energy filling stations the positions of which are extracted, the route changing section selects an energy filling station that the vehicle M can reach first from the current position. In other words, the route changing section 190D selects a route on which the energy filling station that the vehicle M can reach first from the current position is located among the routes which are other than the guiding route and on which energy filling stations are located. In this process, the route changing section 190D may eliminate energy filling stations that the vehicle M is unlikely to reach due to the shortage of energy from the extracted energy filling stations.

The route changing section 190D eliminates the energy filling stations that the vehicle M cannot reach from the current position with reference to the expected energy consumption calculated for each route other than the guiding route by the energy calculating section 190A, for example. This process narrows down the route candidates that the vehicle M is to travel and increases the likelihood of filling the vehicle M with energy. The route changing section 190D calculates a fueling route involving at least the route from the current position of the vehicle M to the selected energy filling station and changes the route that the vehicle M is to travel from the guiding route calculated by the navigation device 50 to the fueling route.

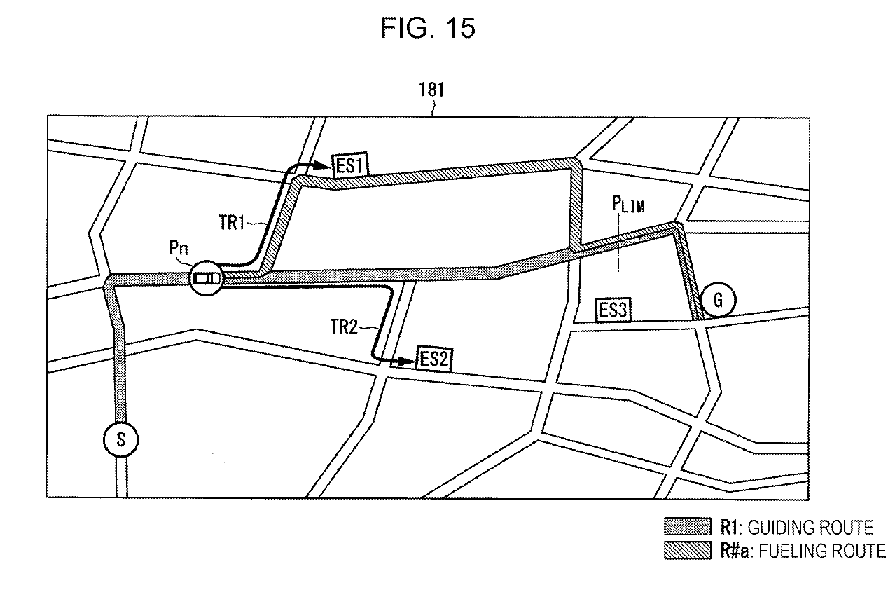

FIG. 15 is a diagram illustrating an example of the situation where the guiding route is changed to the fueling route. R1 in FIG. 15 indicates a guiding route; Pn, the current position of the vehicle M; S, the starting point of automated driving; G, the destination; and ES1 to ES3, energy filling stations. In the example of FIG. 15, there is no energy filling station along the guiding path R1. In the example of FIG. 15, when the vehicle M is located at the current position Pn of the guiding route R1, the filling determination section 190B determines that the vehicle M needs to be filled with energy on the way to the destination G. In this case, the route changing section 190D extracts the energy filling stations ES1 to ES3 on a high-precision map. The route changing section 190D eliminates the energy filling station ES3 from the selectable energy filling stations since the energy filling station ES3 is located at the same distance from the current position Pn as the travel limit point P_{LIM} estimated on the assumption that the vehicle M travels the guiding route R1. The route changing section 190D selects one of the remaining two energy filling stations ES1 and ES2 that the vehicle M can reach earlier. Considering the shortest route from the current position Pn to each energy filling station, for example, route TR1 to the energy filing station ES1 is shorter than route TR2 to the energy filling station ES2 in the example of FIG. 15. The route changing section 190D therefore selects the energy filling station ES1. The route changing section 190D calculates a fueling route R#a composed of the route TR1 for the vehicle M to travel to the energy filling station ES1 and a route from the energy filling station ES1 to the destination G on the high-precision map and changes the route that the vehicle M is to travel from the guiding route R1 to the fueling route R#a. The route to the destination G after the energy filling may be a route that minimizes either the travel distance or a route that minimizes the travel time. The route may partially overlap the original guiding route.

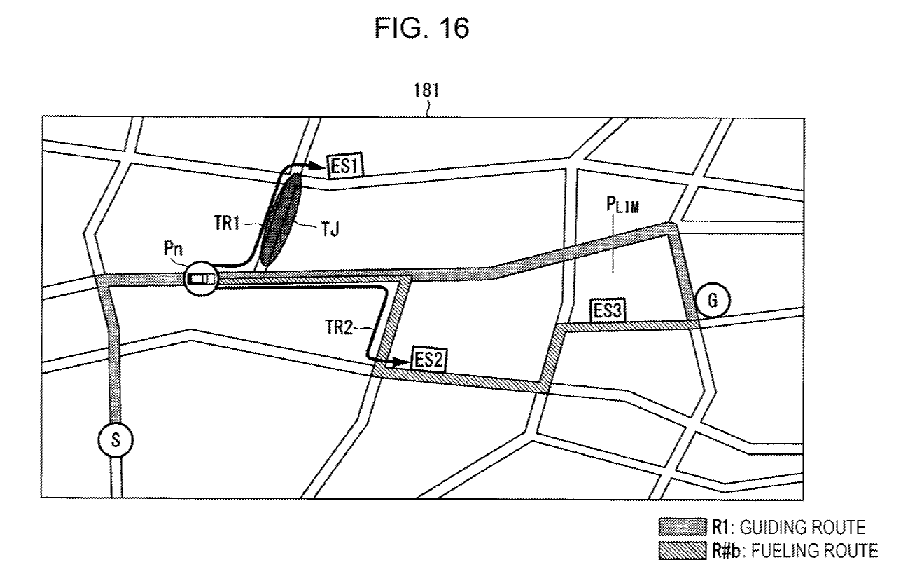

The route changing section 190D may calculate the fueling route with reference to the traffic information received by the communication device 55. FIG. 16 is a diagram illustrating another example of the situation where the guiding route is changed to the fueling route. TJ in FIG. 16 indicates a travel inhibited place where a traffic jam or accident has occurred. At the travel inhibited place TJ, for example, the vehicle M needs to travel at low speed due to a traffic jam or needs to crawl because of traffic regulation due to an accident. Accordingly, it takes longer time for the vehicle M to pass through the zone including the traffic inhibited place TJ than through a zone not involving a traffic jam or accident. The route changing section 190D specifies the position of the travel inhibited place TJ with reference to the traffic information. In FIG. 16, in which the traffic inhibited place TJ is on the route TR1 for the vehicle M to travel to the energy filling station ES1, for example, time T2 taken for vehicle M to reach the energy filling station ES2 is shorter than time T1 taken to reach the energy filling station ES1 in some cases even if the route TR1 is shorter than the route TR2. In other words, the arrival time of the vehicle M at the energy filling station ES2, which is more distant than the energy filling station ES1, is sometimes earlier than the arrival time at the energy filling station ES1. Accordingly, the route changing section 190D calculates the time T1 based on the length of the route TR1 and the expected speed of the vehicle M traveling the route TR1 and calculates the time T2 based on the length of the route TR2 and the expected speed of the vehicle M traveling the route TR2. The route changing section 190D then compares the calculated times T1 and T2 to select the energy filling station that the vehicle M is to be pulled into for energy filling. In the example illustrated in FIG. 16, the time T2 is shorter than the time T1. The route changing section 190D calculates a fueling route R#b composed of the route TR2 to the energy filling station ES2 and a route from the energy filling station ES2 to the destination G on the high-precision map and changes the route that the vehicle M is to travel from the guiding route R1 to the filing route R#b.

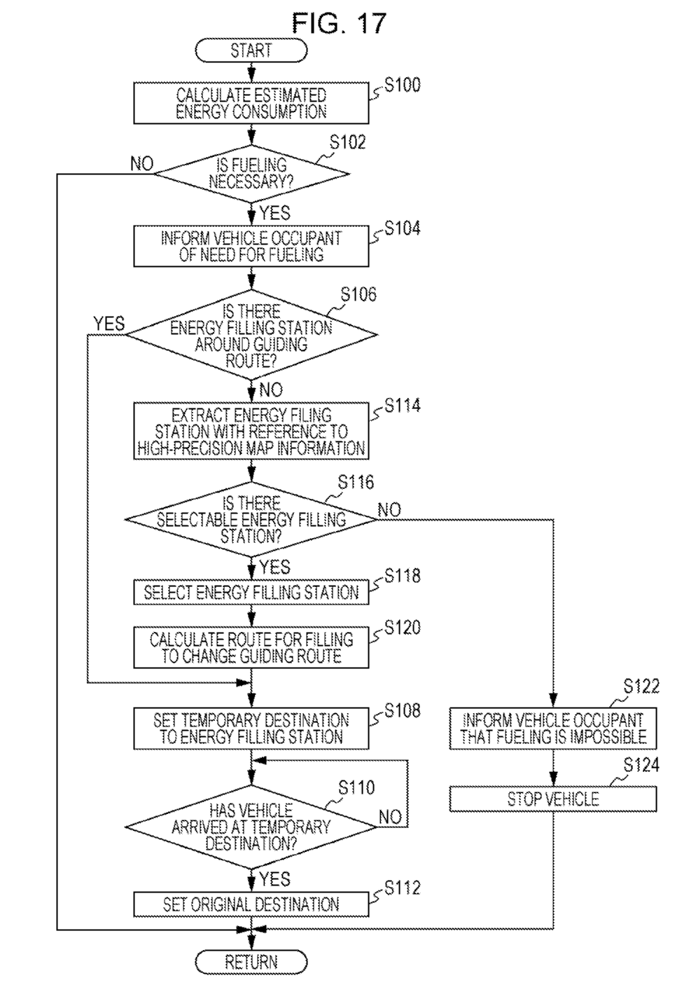

FIG. 17 is a flowchart illustrating an example of the flow of the process performed by the vehicle control system 100 in the first embodiment. The flowchart may be performed before or during the execution of the automated driving mode, for example. The process of the flowchart may be repeatedly performed in a predetermined period.

The energy calculating section 190A calculates expected energy consumption which is an amount of energy expected to be consumed in order for the vehicle M to arrive at the destination based on the guiding route information 182 outputted from the navigation device 50 (Step S100).

Next, based on the remaining energy level measured by the energy level measuring section 95 and the expected energy consumption, the filling determination section 190B determines whether the vehicle M needs to be filled with energy on the way to the destination (Step S102). When the vehicle M does not need to be filled with energy, the filling determination section 190B terminates the process of the flowchart.

On the other hand, when the vehicle M needs to be filled with energy, the information provider 170B informs the vehicle occupant through the display device 82, speaker 83, or the like of the HMI 70 that the vehicle needs to be filled with energy (Step S104). Next, with reference to the guiding route information 182, the filling place determination section 190C determines whether there is an energy filling station around the guiding route to the travel limit point P_{LIM} (Step S106). When there is an energy filling station around the guiding route, the filling place determination 190C sets the provisional destination to the energy filling station (Step S108). When the vehicle M arrives near the energy filling station set as the provisional destination, the trajectory generating section 146 generates a trajectory that leads the vehicle M into the energy filling station from the current lane of the vehicle M and stops the vehicle M at the predetermine position in the energy filling station, for example.

Next, the filling place determination section 190C waits until the vehicle M arrives at the provisional destination (step S110). When the vehicle M arrives at the provisional destination and completes the energy filling, the filling place determination section 190C changes the provisional destination to the original destination (Step S112). In this process, the trajectory generating section 146 generates a trajectory that merges the vehicle M to the original lane form the energy filling station, for example.

When there is no energy filling station around the guiding route, the route changing section 190D extracts energy filling stations on the high-precision map with reference to the high-precision map information 181 (Step S114). Next, the route changing section 190D eliminates an unsuitable energy filling station, from the extracted energy filling stations and determines whether there is a selectable energy filling station (Step S116). The unsuitable energy filling station is an energy filling station which is located at the same distance from the current position of the vehicle M as the travel limit point P_{LIM}. In other words, the unsuitable energy filling station refers to an energy filling station that the vehicle M is less likely to reach with the current remaining energy level.

When there are selectable energy filling stations, the route changing section 190D selects one of the selectable energy filling stations that the vehicle M can reach first (Step S118). Next, the route changing section 190D calculates the fueling route including a route to the energy filling station that the vehicle can reach first and changes the guiding route to the calculated fueling route (Step S120).

On the other hand, when there is no selectable energy filling station as the result of eliminating the unsuitable energy filling station from the extracted energy filling stations, using the display device 82, speaker 83, or the like of the HMI 70, the information provider 170B informs the vehicle occupant that there is no proper energy filling station and the vehicle M cannot be filled with energy.

Next, the route changing section 190D notifies the action plan generating section 144 or trajectory generating section 146 that there is no proper energy filling station. Upon being notified, the action plan generating section 144 changes the current event to an event that stops the vehicle, or the trajectory generating section 146 gradually reducing the intervals of the trajectory points K to generate a trajectory that stops the vehicle M. The automated driving controller 120 thereby automatically stops the vehicle M when the vehicle M does not have enough energy to travel (Step S124). The route changing section 190D may notify the switching controller 150 that there is no proper energy filling station. In this case, the switching controller 150 may switch the driving mode from the automated driving mode to the manual driving mode to hand the operation of the vehicle M over the vehicle occupant. The process of the flowchart is thus terminated.

According to the first embodiment described above, the vehicle control system 100 includes: the automated driving controller 120 configured to execute automated driving that automatically performs at least one of speed control and steering control of the vehicle M so that the vehicle M travel to the set destination; the energy calculating section 190A configured to calculate the expected energy consumption which is expected to be consumed by the vehicle M which is automatically driven and travels a guiding route from the current position of the vehicle M to the destination with reference to an action plan; and the route changing section 190D configured to change the guiding route based on the expected energy consumption calculated by the energy calculating section 190A. Accordingly, the remaining energy level of the vehicle M is managed suitably using automated driving.

### Second Embodiment

Hereinafter, a description is given of a second embodiment. The second embodiment is different from the first embodiment in that the fueling route is calculated using route candidates which are included in the guiding route information 182 and are not selected as the guiding route. Hereinafter, the difference between the first and second embodiments is mainly described.

When it is determined that there is no energy filling station around the guiding route, the filling place determination section 190C of the second embodiment determines whether there is an energy filling station for each route candidate not selected as the guiding route with reference to the guiding route information 182.

The route changing section 190D of the second embodiment changes the route that the vehicle M is to travel from the guiding route to a route candidate which is selected from the route candidates not selected as the guiding route and involves an energy filling station.

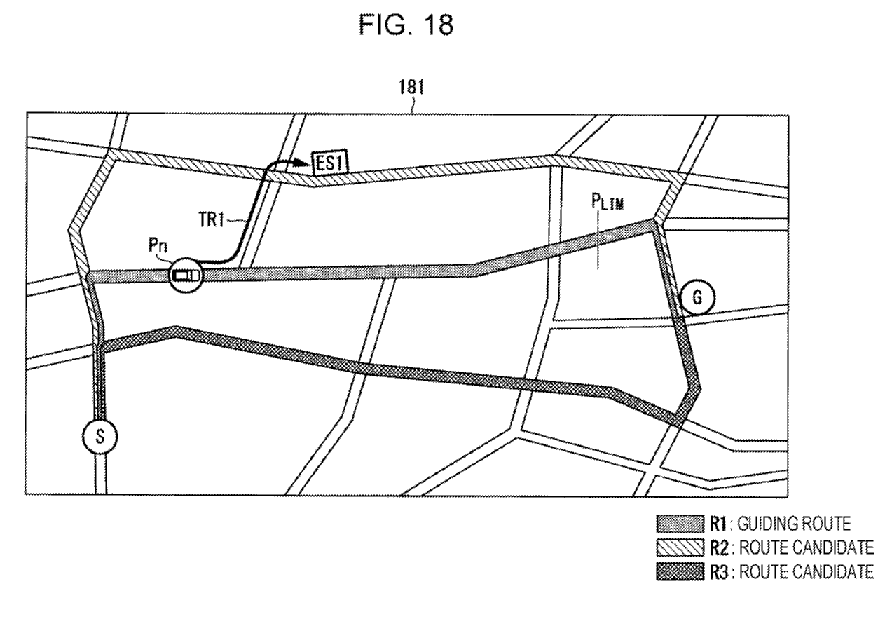

FIG. 18 is a diagram illustrating an example of the situation where the guiding route is changed to a route candidate. R1 in FIG. 1 indicates the guiding route, and R2 and R3 indicate respective route candidates not selected as the guiding route. In the example of FIG. 18, there is an energy filling station on the road specified by the route candidate R2, and there is no energy filling station on the road specified by the route candidate R3. For example, when the filling place determination section 190C determines that there is no energy filling station around the guiding route R1, the route changing section 190D changes the route that the vehicle is to travel from the guiding route R1 to the route candidate R2 involving the energy filling station with reference to the guiding route information 182. In this process, the route changing section 190D calculates a route TR1 from the current position Pn on the guiding route R1 to the route candidate R2 with reference to the high-precision map information 181. The automatic driving controller 120 leads the vehicle M from the current position Pn on the guiding route R1 to the route candidate R2 through route TR1. When the vehicle M enters the route candidate R2, the automated driving controller 120 causes the vehicle M to travel along the route candidate R2 to the destination G.

In the aforementioned example, there is an energy filling station on only one of the plural route candidates. However, the embodiments are not limited to such a situation, there may be an energy filling station on each of plural (two or three, for example) route candidates. In this case, the route changing section 190D calculates the distance from the current position Pn of the vehicle M to the energy filling station (the distance required when the vehicle M travels along the route) involved in each route candidate and selects as a new route, one of the route candidates the distance of which is the shortest. The route changing section 190D may calculate the time for the vehicle M to travel from the current position of the vehicle M to each energy filling station and selects as a new route, one of the route candidates that minimizes the time.

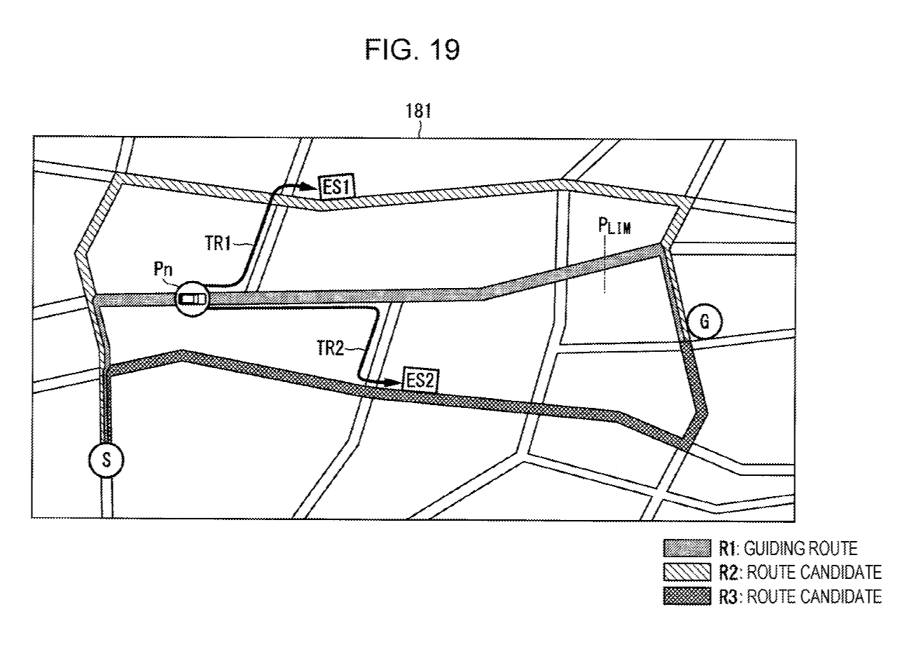

FIG. 19 is a diagram illustrating another example of the situation where the guiding route is changed to the route candidate. In the example of FIG. 19, an energy filling station ES1 is located on the road specified by the route candidate R2, and an energy filling station ES2 is located on the road specified by the route candidate R3. In this case, the route changing section 190D compares the length of the route TR1 from the current position Pn on the guiding route R1 to the energy filling station ES1 with the length of the route TR2 from the current position Pn to the energy filling station ES2. In the example of FIG. 19, since the route TR1 is shorter than the route TR2, the route changing section 190D selects the guiding route R2 as a new route. The route changing section 190D may select the route that the vehicle M is to travel from the plural route candidates with reference to the traffic information in the same way as the first embodiment described above. When there is a traffic jam or the like on the route TR1, for example, the time taken for the vehicle M to reach the energy filling station ES1 is sometimes longer than that to reach the energy filling station ES2, which is more distant from the current position. In such a case, the route changing section 190D may select the guiding route R3 as the route that the vehicle M is to travel.

According to the second embodiment described above, in a similar manner to the aforementioned first embodiment, the guiding route is changed based on the expected energy consumption, and the remaining energy level is therefore managed suitably using automated driving.

Hereinabove, the aspects of the present disclosure are described using the embodiments. However, the present disclosure is not limited to the embodiments, and various modifications and substitutions can be made without departing from the scope of the disclosure.

What is claimed is:

1. A vehicle control system comprising:
an automated driving controller configured to perform automated driving that automatically controls at least one of speed and steering of a vehicle to allow the vehicle to travel a guiding route from a current position of the vehicle to a preset destination based on a plan including the guiding route;
a calculator configured to, referring to the plan of the automated driving, calculate an amount of energy expected to be consumed if the vehicle travels the guiding route from the current position of the vehicle to the destination by the automated driving; and
a route changing section configured to change the guiding route based on the amount of energy calculated by the calculator.

2. The vehicle control system according to claim 1, further comprising:
a first determination section configured to determine, based on the amount of energy calculated by the calculator, whether the vehicle needs to be filled with energy before arriving at the destination; and
a second determination section configured to, when the first determination section determines that the vehicle needs to be filled with the energy, determines whether there is an energy filling station around the guiding route, wherein
the route changing section changes the guiding route when the second determination section determines that there is no energy filling station around the guiding route.

3. The vehicle control system according to claim 2, wherein
when the second determination section determines that there is no energy filling station around the guiding route, the route changing section changes the guiding route to another guiding route on which there is an energy filling station and which allows the vehicle to arrive at the destination.

4. The vehicle control system according to claim 3, further comprising:
a storage which stores map information, wherein
the route changing section is configured to
extract information of energy filling stations existing on a map represented by the map information with reference to the map information stored in the storage,
based on the extracted information of the energy filling stations, select an energy filling station which is first reachable by the vehicle from the current position of the vehicle, and
change the guiding route to a route on which the selected energy filling station is located.

5. The vehicle control system according to claim 2, further comprising:
a guiding route finder configured to find a first guiding route candidate which satisfies a predetermined condition and a second guiding route candidate which does not satisfy the predetermined condition, among a plurality of routes from the current position to the preset destination, the first guiding route candidate being selected as the guiding route, wherein
the second determination section determines whether there is an energy filling station around the second guiding route candidate which does not satisfy the predetermined condition, when the guiding route finder selects the first guiding route candidate as the guiding route, and
when the second determination section determines that there is an energy filling station around the second guiding route candidate, the route changing section changes the guiding route to the second guiding route candidate.

6. A vehicle control method performed by an in-vehicle computer, the method comprising:
performing automated driving that automatically controls at least one of speed and steering of a vehicle to allow the vehicle to travel a guiding route from a current position of the vehicle to a preset destination based on a plan including the guiding route;
with reference to the plan of the automated driving, calculating an amount of energy expected to be consumed if the vehicle travels the guiding route from the current position of the vehicle to the destination by the automated driving; and
changing the guiding route based on the amount of energy thus calculated.

7. A vehicle control program executable by in-vehicle computer, comprising instructions to:
perform automated driving that automatically controls at least one of speed and steering of a vehicle to allow the vehicle to travel a guiding route from a current position of the vehicle to a preset destination based on a plan including the guiding route;
with reference to the plan of the automated driving, calculate an amount of energy expected to be consumed if the vehicle travels the guiding route from the current position of the vehicle to the destination by the automated driving; and
change the guiding route based on the amount of energy thus calculated.
